(19) United States
(12) Patent Application Publication
(10) Pub. No.: US 2013/0276109 A1
(43) Pub. Date: Oct. 17, 2013

(54) System, method and computer program product for detecting activity in association with program resources that has at least a potential of an unwanted effect on the program

(71) Applicant: Ranjan Prakash, Bangalore (IN)

(72) Inventor: Ranjan Prakash, Bangalore (IN)

(73) Assignee: McAFEE, INC.

(21) Appl. No.: 11/484,447

(22) Filed: Jul. 11, 2006

(51) Int. Cl. G06F 21/55

(52) U.S. Cl. CPC G06F 21/554
USPC 726/23

(57) ABSTRACT

A system, method and computer program product are provided. In use, at least one resource utilized by a program is monitored. In addition, activity in association with the at least one resource that has at least a potential of an unwanted effect on the program is detected. Further, a reaction is performed in response to detecting the activity to prevent the unwanted effect.

### FIELD OF THE INVENTION

The present invention relates to program management, and more particularly to managing various aspects of programs.

### BACKGROUND

Once programs are installed or deployed, such programs are typically expected to operate smoothly and warn users proactively in situations where there is a possibility of not being able to perform intended functions. Most programs handle error handle conditions by notifying a user about an inability to perform a desired function. Unfortunately, this type of approach is primarily reactive in nature in that it only tells the user about a problem “after the fact.” This therefore causes programs to deny various functionality until the problem is resolved.

Still yet, other difficulties are rooted in such framework. For example, since any problem is noticed by the program after the fact, the context that caused the problem in the first place is sometimes lost, etc. This, in turn, makes root cause analysis significantly harder.

There is thus a need for overcoming these and/or other problems associated with the prior art.

### SUMMARY

A system, method and computer program product are provided. In use, at least one resource utilized by a program is monitored. In addition, activity in association with the at least one resource that has at least a potential of an unwanted effect on the program is detected. Further, a reaction is performed in response to detecting the activity to prevent the unwanted effect.

### BRIEF DESCRIPTION OF THE DRAWINGS

FIG. 1 illustrates a network architecture, in accordance with one embodiment.

FIG. 2 shows a representative hardware environment that may be associated with the server computers and/or client computers of FIG. 1, in accordance with one embodiment.

FIG. 3A shows a method for detecting activity in association with program resources that has at least a potential of an unwanted effect on the program, in accordance with one embodiment.

FIG. 3B shows a method for disabling a first function of a program to prevent an unwanted effect on a second function of the program, in accordance with another embodiment.

FIG. 4 shows a method for detecting activity in association with program resources that has at least a potential of an unwanted effect on the program based on a user-configuration, in accordance with yet another embodiment.

FIG. 5 shows a method for disabling a first function of a program to prevent an unwanted effect on a second function of the program based on a priority of the functions, in accordance with still yet another embodiment.

FIG. 6 shows a graphical user interface for selecting and prioritizing functions associated with a computer program, in accordance with another embodiment.

FIG. 7 shows a graphical user interface for configuring reactions of detected activity in association with program resources that has at least a potential of an unwanted effect on the program, in accordance with yet another embodiment.

### DETAILED DESCRIPTION

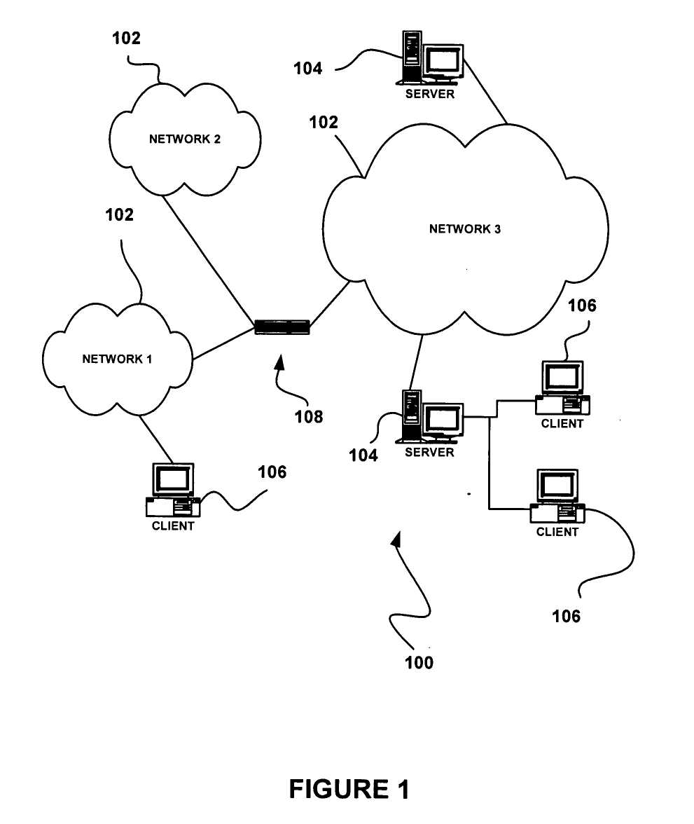

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wireless network, a wide area network (WAN) such as the Internet, peer-to-peer network, etc.

Coupled to the networks 102 are server computers 104 which are capable of communicating over the networks 102. Also coupled to the networks 102 and the server computers 104 is a plurality of client computers 106. Such server computers 104 and/or client computers 106 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 102, at least one gateway 108 is optionally coupled therebetween.

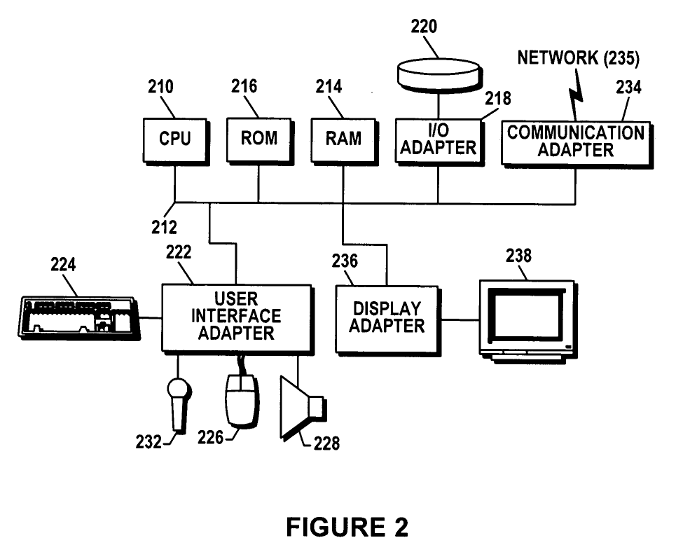

FIG. 2 shows a representative hardware environment that may be associated with the server computers 104 and/or client computers 106 of FIG. 1, in accordance with one embodiment. Such figure illustrates a typical hardware configuration of a workstation in accordance with one embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Of course, the various embodiments set forth herein may be implemented utilizing hardware, software, or any desired combination thereof. For that matter, any type of logic may be utilized which is capable of implementing the various functionality set forth herein.

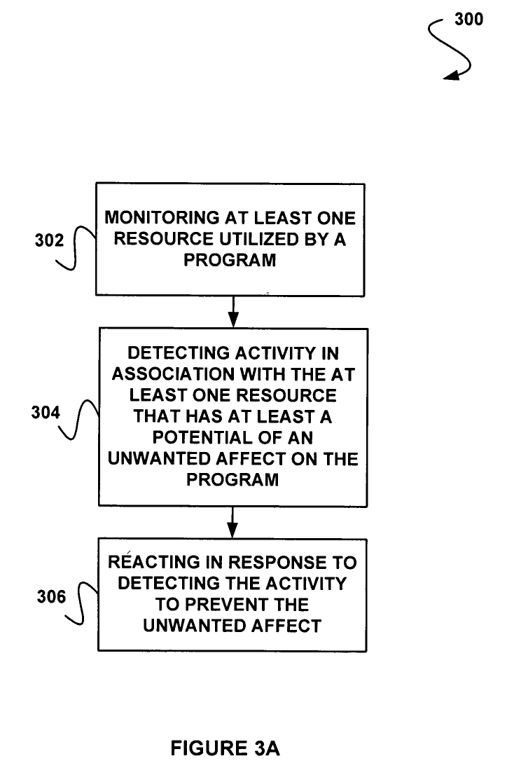

FIG. 3A shows a method 300 for detecting activity in association with program resources that has at least a potential of an unwanted effect on the program, in accordance with one embodiment. As an option, the method 300 may be implemented in the context of the architecture and environment of FIGS. 1 and/or 2. Of course, however, the method 300 may be carried out in any desired environment.

As shown in operation 302, at least one resource utilized by a program is monitored. The program may include any application capable of being executed on a computer. For example, the program may include a word processing application, an e-mail application, a web application, a security application, etc. Additionally, the computer may optionally include any of the computers described above with respect to FIGS. 1 and/or 2.

Further, the at least one resource utilized by the program may include a network resource, a processing resource, a storage resource, a registry resource and/or any other resource capable of being utilized by a program. Specifically, and by way of example only, the resource may, in various embodiments, include disk space utilized by the program, registry keys utilized by the program, bandwidth utilized by the program, processor usage utilized by the program, files utilized by the program, a printer utilized by the program, etc.

Of course, such resources may be monitored in any desired manner. For instance, the resource may be monitored directly (e.g. by detecting and/or measuring usage in association with disk space, bandwidth, processing capacity, file access, etc.). Further, in other embodiments, calls of an operating system running in association with the program may also be monitored utilizing a hooking application or the like. More information regarding such optional feature will be set forth hereinafter in greater detail. Thus, any resources utilized by the program may be monitored in any desired manner.

Still yet, activity in association with the at least one resource that has at least a potential of an unwanted effect on the program may be identified, as shown in operation 304. The activity may include, for example, any action performed by at least one other program (and/or even the instant program) that is associated with at least one resource. In one optional embodiment, the activity may include at least one function performed by the other program(s). Furthermore, such function may utilize resources also utilized by the program. For example, in different embodiments, the function may include a print function, an email function, an Internet function, a query function, and/or any other function that utilizes one or more resources, at least in part.

In other embodiments, the activity may include any action that meets predetermined thresholds associated with specific types of activity. For example, the activity may include usage of a predetermined amount of disk space, usage of specific predetermined registry keys, usage of a predetermined amount of bandwidth, usage of a predetermined amount of processor power/capabilities, etc. Of course, however, the activity may include any activity associated with at least one resource utilized by the program. Thus, the activity may include any type of activity performed by another program that utilizes resources also utilized by the program.

In still other embodiments, the activity of the other program may have a potential of an unwanted effect on the program by consuming at least one resource utilized by the program. In one embodiment, the unwanted effect may include an error in association with the program. For example, the instant program may be unable to execute a particular function due to the activity of the other program. Specifically, the other program may utilize a resource utilized by the instant program to the extent that such resource becomes unavailable to the instant program. Of course, it should be noted that the unwanted effect may include any unwanted functionality associated with the instant program.

Moreover, a reaction may be performed in response to detecting the activity, in order to prevent the unwanted effect. See operation 306. In one optional embodiment, the reaction may be user-configured. Of course, however, the reaction may also include default reactions. For example, the reaction may include alerting a user of the activity, terminating any processes and/or application associated with the activity, temporarily stopping the activity until the program has finished utilizing the associated resource, and/or any other reaction capable of being taken in response to detecting such activity to prevent any unwanted effect.

As an optional embodiment, hooks within an operating system utilized by the program may be implemented to perform the reaction. In particular, the hooks may trap commands associated with activity that has at least a potential of an unwanted effect on the program. Actions may then be taken with respect to such trapped commands (e.g. blocking the commands, etc.) in order to prevent the unwanted effect.

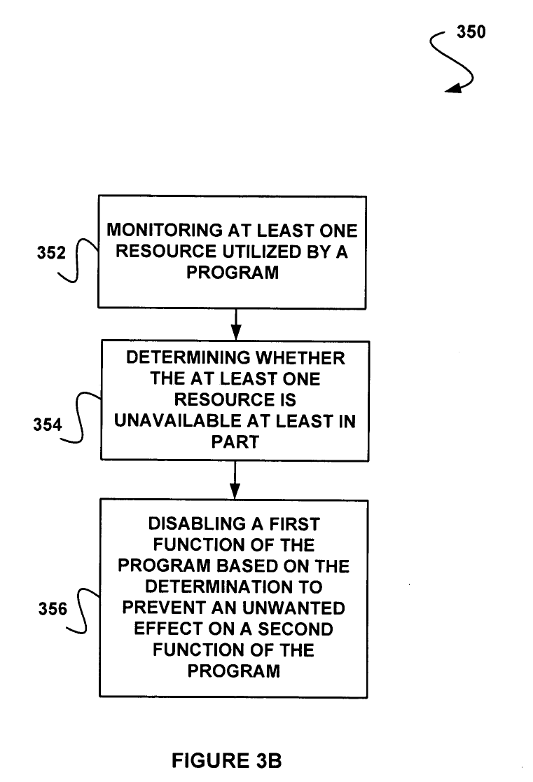

In one embodiment, the monitoring of operation 302 and the detecting of operation 304 may be performed utilizing an application that is installed with the program as single package. In another embodiment, such functionality may be performed utilizing a separate application. In any case, a single program or a plurality of programs may be monitored and protected against potential unwanted effects. More information regarding one optional embodiment which may or may not incorporate some or all of the foregoing features will be set forth in the context of FIG. 4.

FIG. 3B shows a method 350 for disabling a first function of a program to prevent an unwanted effect on a second function of the program, in accordance with another embodiment. As an option, the method 350 may be implemented in the context of the architecture and environment of FIGS. 1-3A. Of course, however, the method 350 may be carried out in any desired environment. It should also be noted that the aforementioned definitions may apply during the present description.

As shown in operation 352, at least one resource utilized by a program is monitored. Optionally, in one optional embodiment, extended markup language (XML) may be utilized to report a status of the at least one resource. In other embodiments, the resource(s) may or may not be monitored in a manner set forth in operation 302 of FIG. 3A. Of course, in still other embodiments, the monitoring may be carried out in any desired manner.

In addition, it is determined whether the at least one resource is unavailable at least in part, as shown in operation 354. In one optional embodiment, the source causing the at least in part unavailability of the resource may or may not be identified.

In one embodiment, the resource may be unavailable (at least in part) due to a failure of the resource. In another embodiment, the resource may be unavailable at least in part due to activity of another program. In still yet another embodiment, the resource may be unavailable due to usage by a function within the program. Of course, the resource may be unavailable for any reason, for that matter.

As shown in operation 306, a first function of the program may be disabled based on the determination to prevent an unwanted effect on a second function of the program. Thus, in one embodiment, if it is determined that the at least one resource is unavailable at least in part due to usage by another function associated with the program, the first function of the program may be disabled to prevent any unwanted effect on the second function of the program.

For example, in one optional embodiment, it may be determined whether the at least one resource is unavailable to the extent that either the first function or the second function of the program can not be performed. As an option, the first function may be disabled based on a priority of the first function and a priority of the second function. In particular, priorities of the first function and second function may be identified and compared to determine which function to prevent from accessing the associated resource. For instance, if the second priority is higher than the first priority, then the first function may be disabled.

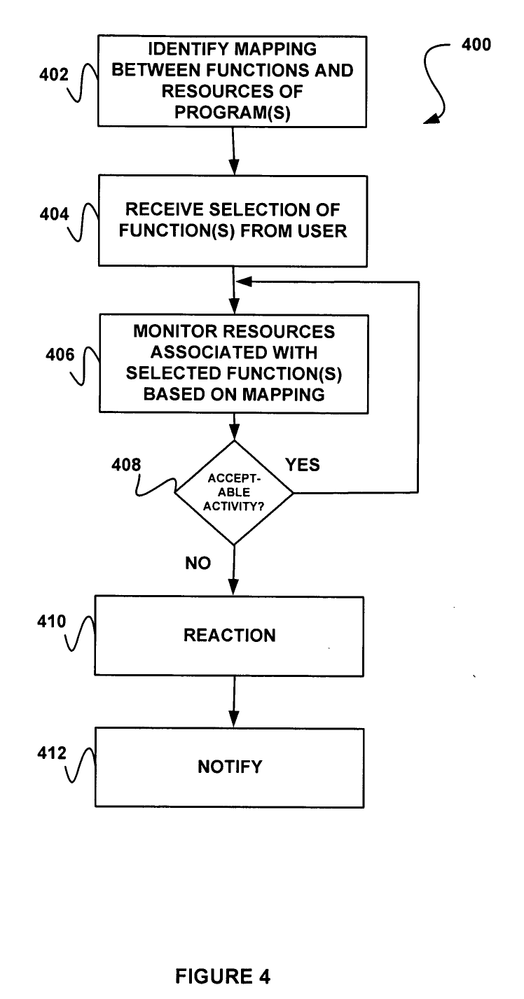

In this way, the most important functions may have priority over resources utilized in a program. One example of disabling functions based on priority will be described in further detail with respect to FIG. 5.

Moreover, in other embodiments, it may also be determined whether disabling the first function at least potentially results in the at least one resource becoming available. In this way, the first function may be disabled based on such a determination. Specifically, the first function may be disabled if it is determined that disabling such first function will at least potentially result in at least one resource becoming available.

In still yet other embodiments, the first function and the second function may be identified by receiving a selection from a user utilizing a graphical user interface. For example, the first function and the second function may be selected from a plurality of available functions of the program. Furthermore, resources may be monitored based on such selected first function and second function.

Specifically, resources to be monitored may be identified based on a mapping between a plurality of functions and a plurality of resources. Such mapping will be described in further detail with respect to FIG. 4. In this way, a user may customize which resources are monitored. Thus, resources utilized by a program may be monitored to prevent any unavailability of such resources specific to selected functions of the program.

More illustrative information will now be set forth regarding various optional architectures and features with which the foregoing techniques may or may not be implemented, per the desires of the user; It should be strongly noted that the following embodiments are set forth for illustrative purposes and should not be construed as limiting in any manner. Any of the following features may be optionally incorporated with or without the exclusion of other features described.

FIG. 4 shows a method for detecting activity in association with program resources that has at least a potential of an unwanted effect on the program based on a user-configuration, in accordance with yet another embodiment. As an option, the method 400 may be implemented in the context of the architecture and environment of FIGS. 1-3B. Of course, however, the method 400 may be carried out in any desired environment. It should also be noted that the aforementioned definitions may apply during the present description.

As shown in operation 402, a mapping between functions and resources of at least one program may be identified. As an option, functions associated with a plurality of programs may be mapped to resources utilized by such functions. Such mapping may be received in conjunction with each program. Of course, however, the mapping may be received in any desired manner.

In addition, the map may be stored in any desired way. For example, the mapping may be stored in a database.

Table 1 illustrates an exemplary mapping between functions and resources. It should be noted that such mapping is set forth by way of example only, and should not be construed as limiting in any manner.

TABLE 1

| FUNCTION | RESOURCE |
|---|---|
| E-Mail service | STMP connection |
| Internet services | HTTP connection; Bandwidth |
| Print service | Printer |
| Write function | Disk space |
| Real-time process | Processor |

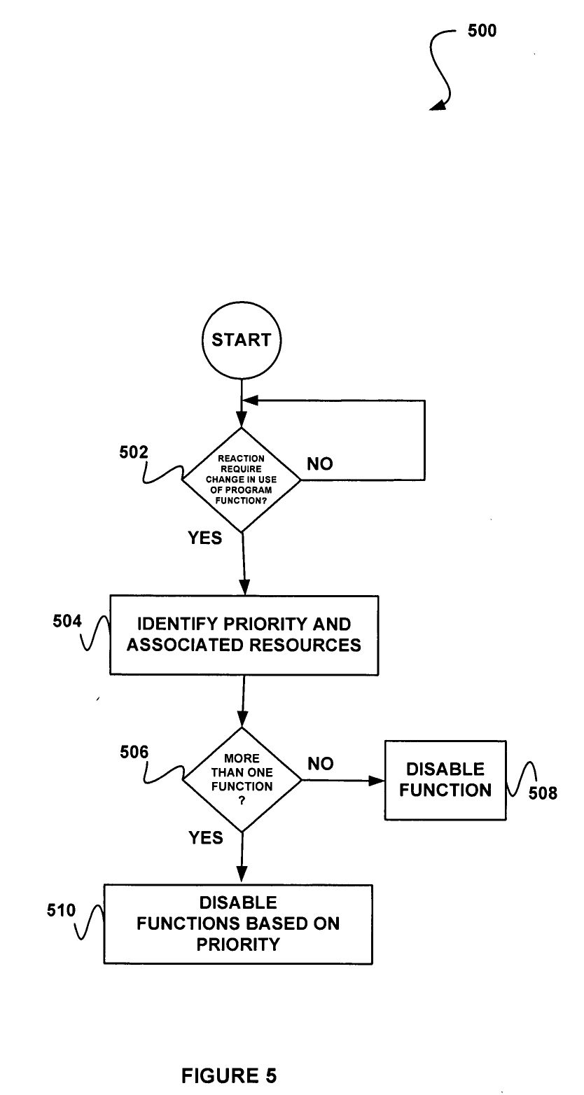

Further, a selection of at least one function of a program may be received from a user, as shown in operation 404. For example, the at least one function may be selected utilizing a graphical user interface (GUI). As another example, the at least one function may be selected from a plurality of available functions of the program. One example of such a GUI will be described in more detail with respect to FIG. 6.

As an option, the at least one function may be selected by the user based on an importance of the function to the user. In particular, functions that are utilized by the user may be selected. Thus, at least one function may be identified. Further, in some embodiments, the function(s) may or may not be identified during a set-up of the program. Of course, however, the at least one function may be identified in any desired manner.

Resources associated with any selected functions may then be monitored based on the mapping, as shown in operation 406. In one embodiment, at least one resource may be identified and therefore monitored based on the selected function(s). For instance, the resources utilized by and/or required by the selected function(s) may be identified from the mapping of functions to resources.

It may then be determined whether identified activities associated with the monitored resources are acceptable, as shown in decision 408. Such identified activity may include an activity performed by any program. Furthermore, the activity may be identified based on usage of at least a portion of one of the monitored resources.

For example, the activity may be determined to be acceptable if such activity does not render the associated resource unavailable to other functions. In one optional embodiment, the activity may be determined to be acceptable if the activity does not make the associated resource unavailable to functions with a greater priority than the priority of functions associated with such activity. In another optional embodiment, the activity may be determined to be acceptable based on a predefined threshold associated with the particular type of activity. Of course, however, such activity may be determined to be acceptable based on any desired criteria.

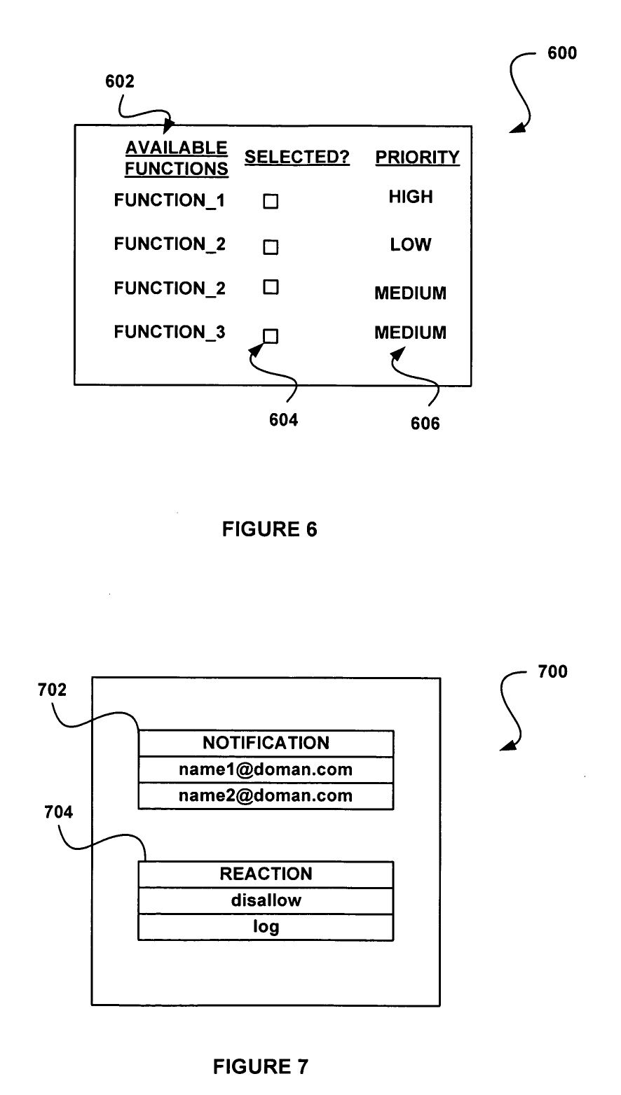

If the activity is determined to be acceptable, the resources may continue to be monitored in operation 406. If, however, it is determined that the activity is not acceptable, a reaction may be performed, as shown in operation 410. The reaction may optionally be user-configurable. Such reaction may be configured utilizing a GUI. One example of such user-configuration will be described in more detail with respect to FIG. 7. Of course, however, the reaction may also include default reactions.

The reaction may include, for example, a notification, alerting a user of the activity, preventing the activity by terminating any processes and/or application associated with the activity, temporarily stopping the activity until a higher priority function has finished utilizing the associated resource and/or any other reaction capable of being taken in response to detecting such activity. Still yet, a user may then be notified of the activity and of the reaction performed in response to the activity, as shown in operation 412. Such notification may be performed utilizing e-mail, a pop-up window, a text message, etc. In this way, resources may be monitored and utilized according to user specifications.

FIG. 5 shows a method 500 for disabling a first function of a program to prevent an unwanted effect on a second function of the program based on a priority of the functions, in accordance with still yet another embodiment. As an option, the method 500 may be implemented in the context of the architecture and environment of FIGS. 1-4. For example, the method 500 may be optionally carried out in conjunction with the operation 410 of FIG. 4, to determine if a program's own activity (e.g. function, etc.) requires disablement, to prevent any unwanted effect. Of course, however, the method 500 may be carried out in any desired environment. It should also be noted that the aforementioned definitions may apply during the present description.

As shown in decision 502, it is determined whether a reaction is to be performed that requires a change of function of an instant program. For example, in one embodiment, it may be determined whether a reaction requires one function of the instant program to be terminated such that another function of such program may utilize an associated resource. In another exemplary embodiment, it may be determined whether a reaction requires one function to be suspended until another function utilizes an associated resource. In still another embodiment, a single function may be the sole cause of a potential unwanted effect. Of course, in still other embodiments, anything that requires a change in a program function may be identified.

If the decision 502 is answered in the affirmative, any priorit(ies) and resource(s) of one or more respective function(s) is identified, as shown in operation 504. For example, in one embodiment, a first priority associated with a currently running function and a second priority associated with a function that is being initiated are both identified along with any resources associated therewith. The priorities may optionally be identified from a database of priorities, where each priority is associated with a particular function. As another option, similar to previous embodiments, the priorities may be user-configured utilizing a GUI. Again, one example of such a GUI will be described in more detail with respect to FIG. 6.

It may also be determined whether more than one function is involved, as shown in decision 506. As described above in the context of one optional embodiment, more than one function may be involved if one function is to be terminated so that another function may run, etc. If only one function is involved, such function may simply be disabled, as shown in operation 508. Of course, such function may be disabled in any desired manner. For example, the function may be terminated, suspended, etc.

If, however, more than one function is involved, only a subset of function(s) (e.g. a single function, etc.) may be disabled based on priority, so that a higher priority function(s) may continue. Specifically, a function with lesser priority may be disabled and thereby prevented from utilizing a resource so that a function with higher priority may utilize such resource. In this way, a resource may be utilized based on priority of functions in order to prevent any unwanted errors in the execution of a program, etc.

FIG. 6 shows a GUI 600 for selecting and prioritizing functions associated with a computer program, in accordance with another embodiment. As an option, the GUI 600 may be implemented in the context of the architecture and environment of FIGS. 1-5. Of course, however, the GUI 600 may be carried out in any desired environment. It should also be noted that the aforementioned definitions may apply during the present description.

As shown, the GUI 600 may allow a user to select and prioritize functions available within a program. Specifically, the GUI 600 may list the available functions 602. Further, the user may be allowed to select from the list of available functions 602 utilizing check boxes 604. Of course, however, functions from such list of available functions 602 may be selected in any desired manner.

In addition, the user may be allowed to change a priority 606 of such selected functions. Each available function 602 may be associated with a default priority 606. A user may therefore choose to maintain the default priority 606 or change the default priority 606. In this way, a user may configure priorities of functions within a computer program, such that functions with higher priority may be allowed to utilize resources first whenever there is a conflict with respect to multiple functions desiring to utilize the resource.

FIG. 7 shows a GUI 700 for configuring reactions of detected activity in association with program resources that has at least a potential of an unwanted effect on the program, in accordance with yet another embodiment. As an option, the GUI 700 may be implemented in the context of the architecture and environment of FIGS. 1-6. Of course, however, the GUI 700 may be carried out in any desired environment. It should also be noted that the aforementioned definitions may apply during the present description.

As shown, the GUI 700 may allow a user to configure notification 702 and reaction 704 settings associated with potentially unwanted effects. In particular, a user may configure types of notifications and specific addresses to notify within the notification 702 setting. As shown, a user may specify e-mail addresses to notify in the case of a potentially unwanted effect being identified. Of course, however, the user may also specify phone numbers, pop-up options, instant message address, etc. In addition, the notification 702 setting may be utilized to notify a user when a reaction has been performed in response to a potentially unwanted effect being identified.

Further, the reaction 704 settings may allow a user to configure a reaction to be performed in response to a potentially unwanted effect being identified. As specifically shown, the reaction 704 settings may include a disallow option and/or a log option. It should be noted, however, that any desired reaction 704 setting may be configured by a user. In addition, the reaction 704 settings may also allow a user to specify a particular reaction for each type of potentially unwanted effect.

In one embodiment, terrorism may be countered utilizing the aforementioned technology. According to the U.S. Federal Bureau of Investigation, cyber-terrorism is any “premeditated, politically motivated attack against information, computer systems, computer programs, and data which results in violence against non-combatant targets by sub-national groups or clandestine agents.” A cyber-terrorist attack is designed to cause physical violence or extreme financial harm. According to the U.S. Commission of Critical Infrastructure Protection, possible cyber-terrorist targets include the banking industry, military installations, power plants, air traffic control centers, and water systems.

Thus, by optionally incorporating the present technology into the cyber-frameworks of the foregoing potential targets, terrorism may be countered by detecting activity in association with program resources that has at least a potential of an unwanted effect on the program, which may be used to combat cyber-terrorism.

While various embodiments have been described above, it should be understood that they have been presented by way of example only, and not limitation. For example, any of the network elements may employ any of the desired functionality set forth hereinabove. Thus, the breadth and scope of a preferred embodiment should not be limited by any of the above-described exemplary embodiments, but should be defined only in accordance with the following claims and their equivalents.

What is claimed is:

1. A method, comprising:
selecting a first function and a second function of a plurality of functions of a computer program;
monitoring at least one resource associated with the first function and the second function, utilizing a processor;
detecting activity by the first function in association with the at least one resource that has at least a potential of an unwanted effect on the second function; and
reacting in response to detecting the activity to prevent the unwanted effect, comprising:
determining that the second function has a higher priority than the first function; and
temporarily disabling the first function until the second function has finished utilizing the at least one resource.

2. The method of claim 1, further comprising identifying the first function and the second function.

3. The method of claim 2, wherein the first function and second function are identified by receiving a selection of the first function and the second function from a user.

4. The method of claim 1, wherein the first function and the second function are selected by a user utilizing a graphical user interface.

5. (canceled)

6. The method of claim 1, wherein the at least one resource that is monitored is identified based on the first function and the second function.

7. (canceled)

8. The method of claim 6, wherein the at least one resource that is monitored is identified based on a mapping between a plurality of functions and a plurality of resources.

9. The method of claim 1, wherein the at least one resource includes at least one of a network resource, a processing resource, a storage resource, and a registry resource.

10. The method of claim 1, wherein the monitoring includes monitoring calls associated with an operating system running in association with the first function and the second function.

11. (canceled)

12. The method of claim 1, wherein the unwanted effect includes an error in association with the second function.

13. The method of claim 1, wherein the act of reacting is user- configurable.

14. The method of claim 13, wherein the act of reacting is user-configurable utilizing a graphical user interface.

15. The method of claim 1, wherein the act of reacting includes sending a notification.

16. The method of claim 1, wherein the act of reacting includes preventing the activity.

17. (canceled)

18. The method of claim 1, wherein the act of reacting is performed for combating terrorism.

19. A computer program product embodied on a non-transitory tangible computer readable medium, comprising:
computer code for selecting a first function and a second function of a plurality of functions of a computer program;
computer code for monitoring at least one resource associated with a first function and a second function;
computer code for detecting activity by the first function in association with the at least one resource that has at least a potential of an unwanted effect on the second function; and
computer code for reacting in response to detecting the activity to prevent the unwanted effect, comprising:
computer code for terminating the first function responsive to determination that the second function has a higher priority than the first function.

20. A system, comprising:
a processor;
a program, executable on the processor, comprising a plurality of functions; and
an application, executable on the processor, for
selecting the first function and the second function from the plurality of functions;
detecting activity by the first function in association with at least one resource that has at least a potential of an unwanted effect on the second function; and
performing a reaction in response to detecting the activity to prevent the unwanted effect, comprising:
suspending the first function temporarily if the second function has a higher priority than the first function.

21. The method of claim 10, wherein the calls associated with the operating system running in association with the program are monitored utilizing a hooking application.

22. The method of claim 1, wherein hooks within an operating system utilized by the first function and the second function are implemented to perform the act of reacting.

23. The method of claim 1, wherein the act of reacting further comprises:
reporting a status of the at least one resource using a markup language.
